(19) United States
(12) Patent Application Publication
(10) Pub. No.: US 2008/0155914 A1
(43) Pub. Date: Jul. 3, 2008

(54) Window and door construction

(75) Inventor: Daniel M. Schlabach, Berlin, OH (US)

Correspondence Address: SAND & SEBOLT, AEGIS TOWER, SUITE 1100, 4940 MUNSON STREET, NW, CANTON, OH, 44718-3615, US

(73) Assignee: Little Cottage Company, Millersburg, OH (US)

(21) Appl. No.: 11/999,587

(22) Filed: Dec. 6, 2007

Related U.S. Application Data
(60) Provisional application No. 60/877,968, filed on Dec. 29, 2006.

(51) Int. Cl. E06B 3/00; E06B 1/04

(52) U.S. Cl. 52/211; 52/204.5; 52/204.61; 52/204.53

(57) ABSTRACT

A construction system includes a window assembly and a door assembly preferably having similar shapes. The window assembly includes a window frame defining a window opening and at least two window pane assemblies which may typically be opened and closed. A first portion of the window opening has a first shape and one of the window pane assemblies covers the first portion of the window opening and has an outer perimeter with a second shape different than the first shape. A thin layer of material on a window pane may form a divider creating an appearance that the window pane is a plurality of window panes. The door assembly includes a door frame with an inner circumference defining a door opening with one shape and a door which covers the door opening and has an outer circumference with another shape different than the shape of the door opening.

### CROSS REFERENCE TO RELATED APPLICATIONS

This application claims priority from U.S. Provisional Application Ser. No. 60/877,968 filed Dec. 29, 2006; the disclosure of which is incorporated herein by reference.

### BACKGROUND OF THE INVENTION

1. Technical Field

The present invention relates generally to door and window construction. More particularly, the invention relates to doors and windows in which the door opening or window opening is typically not square or rectangular and the door or window pane assembly is typically square or rectangular.

2. Background Information

Most doors and windows have a square or rectangular shape although other shapes are known. However, the formation of doors and windows having irregular shapes is substantially more difficult and time consuming than forming those which are square or rectangular. This may be due to the requirement of cutting a curved border or providing a curved piece of wood or other material, or due to the formation of inwardly projecting angles which may require complex mitering in order to provide an aesthetic appearance. Some of these problems are specifically addressed in copending patent application entitled Window And Window Frame Construction having Ser. No. 11/545,919, which was filed on Oct. 11, 2006 and which is incorporated herein by reference. The door and window of the present invention addresses the various above-noted problems.

### BRIEF SUMMARY OF THE INVENTION

The present invention provides an apparatus comprising: a window frame defining a window opening; a first inner perimeter defining a first portion of the window opening having a first shape; a second inner perimeter defining a second portion of the window opening; a first window pane assembly which is mounted on the window frame, comprises a first window pane and has a first outer perimeter larger than the first inner perimeter so that the first window pane assembly is capable of covering the first portion of the window opening; the first outer perimeter having a second shape different than the first shape; a second window pane assembly which is mounted on the window frame, comprises a second window pane and has a second outer perimeter larger than the second inner perimeter so that the second window pane assembly is capable of covering the second portion of the window opening; at least one of the window pane assemblies being movable between open and closed positions.

The present inventing further provides an apparatus comprising: a door frame having an inner circumference of a first shape defining a door opening; and a door mounted on the door frame and having an outer circumference which is greater than the inner circumference and has a second shape different than the first shape.

### BRIEF DESCRIPTION OF THE SEVERAL VIEWS OF THE DRAWINGS

FIG. 1 is a front elevational view of the arched window and a first embodiment of the arched door assembly of the present invention mounted on a wall.

FIG. 2 is an enlarged front elevational view of the first embodiment of the door mounted on the wall.

FIG. 3 is a rear elevational view of the first embodiment of the door.

FIG. 4 is a sectional view taken on line 4-4 of FIG. 2 showing the door in the closed position.

FIG. 5 is a sectional view similar to FIG. 4 showing the door in an open position.

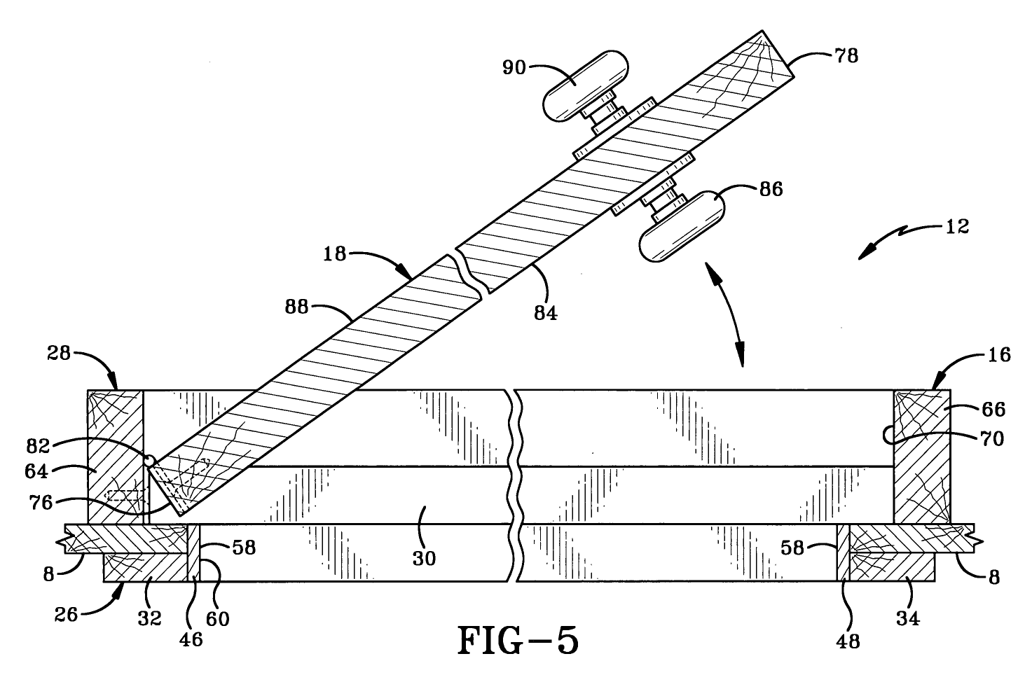

FIG. 6 is a front elevational view of a second embodiment of the door assembly of the present invention showing a sliding door in a partially opened position.

FIG. 7 is an enlarged front elevational view of the window of the present invention in the closed position.

FIG. 8 is a rear elevational view of the window in the closed position.

FIG. 9 is a sectional view taken on line 9-9 of FIG. 7.

FIG. 10 is a sectional view taken on line 10-10 of FIG. 7.

FIG. 11 is a front elevational view of the window showing the lower window pane assembly raised to an open position.

FIG. 12 is a front elevational view of the window showing the upper window pane assembly lowered to an open position.

### DETAILED DESCRIPTION OF THE INVENTION

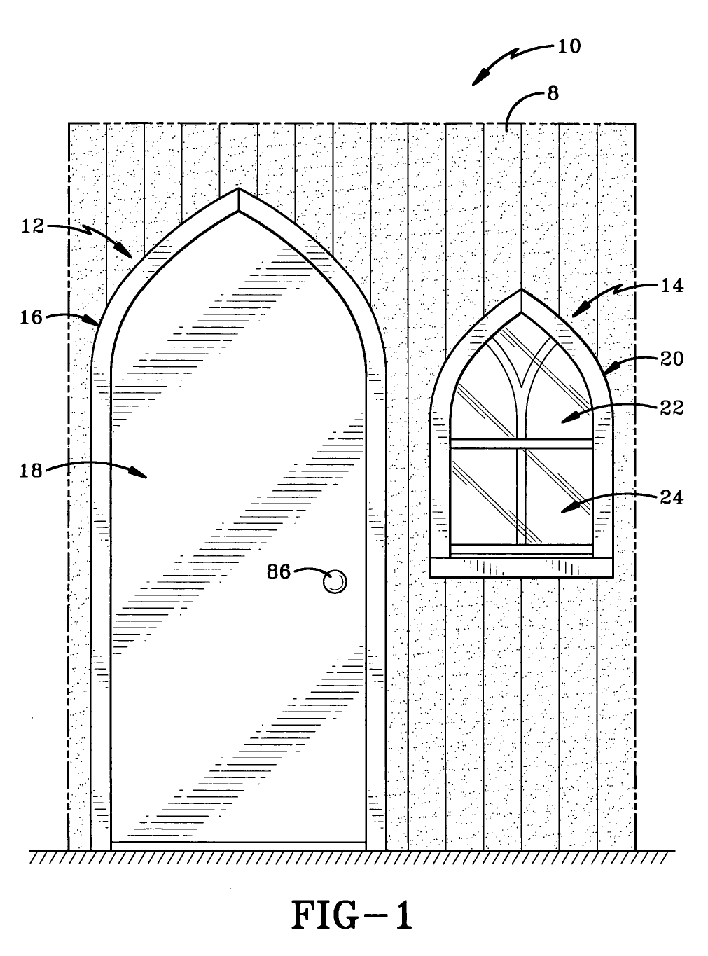

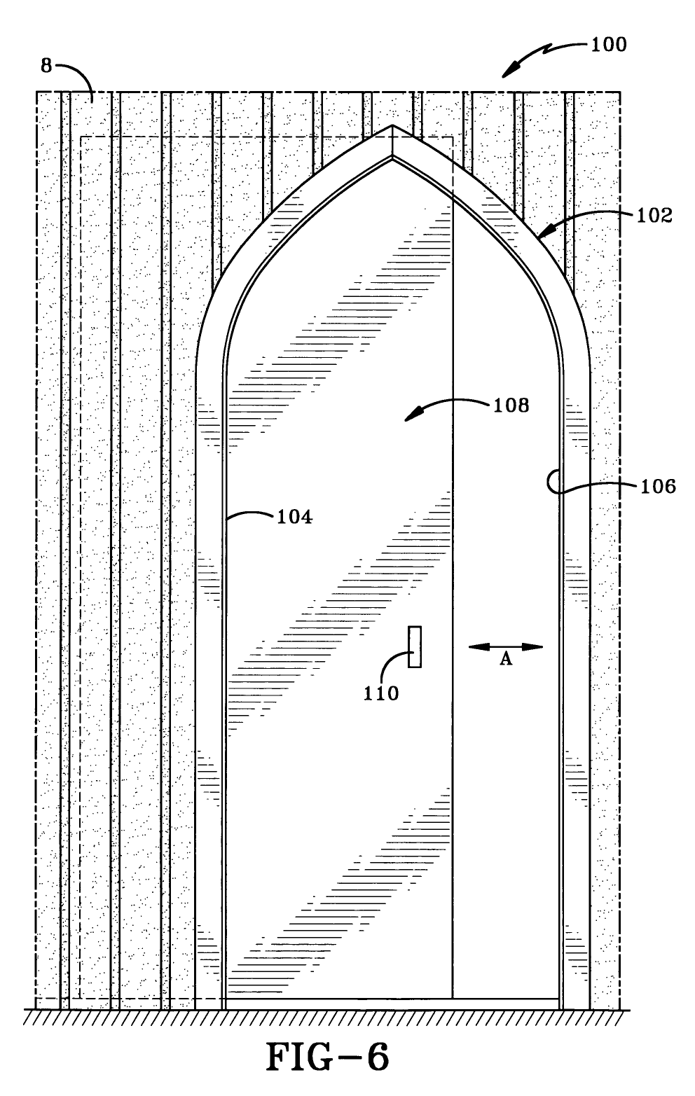

The door and window construction of the present invention is indicated generally at 10 in FIG. 1 and includes a first embodiment of a door assembly 12 and a window 14 mounted on a wall 8. A second embodiment of the door assembly of the present invention is indicated generally at 100 in FIG. 6. Referring to FIG. 1, door assembly 12 includes a door frame 16 and a door 18 pivotally mounted thereon. Window 14 includes a window frame 20, an upper window pane assembly 22 and a lower window pane assembly 24 each of which is moveable between open and closed positions.

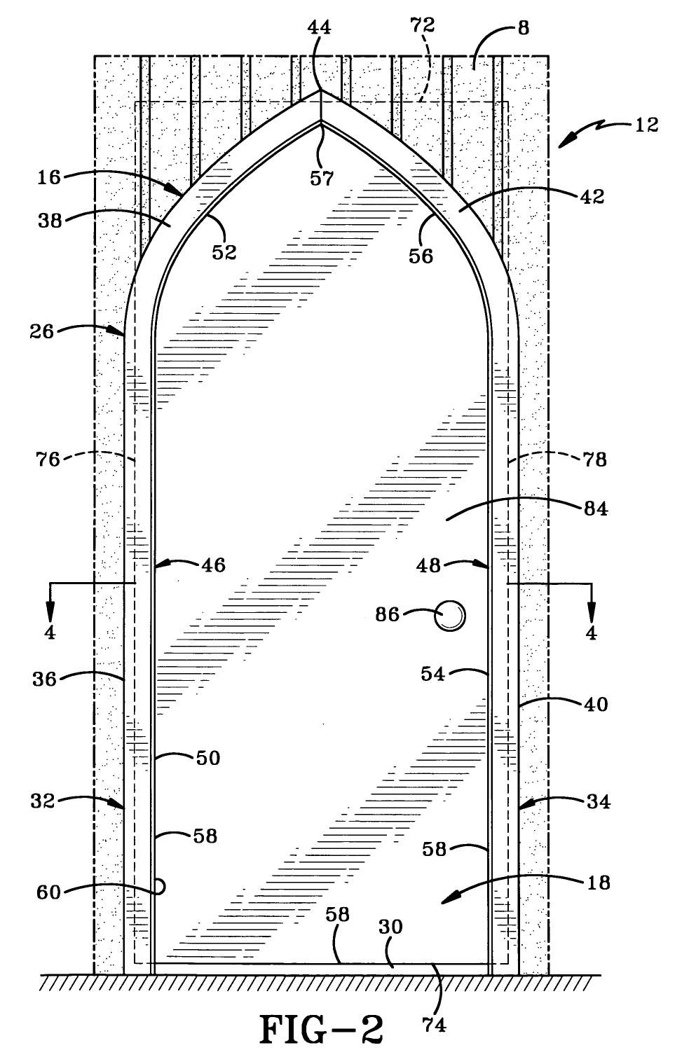

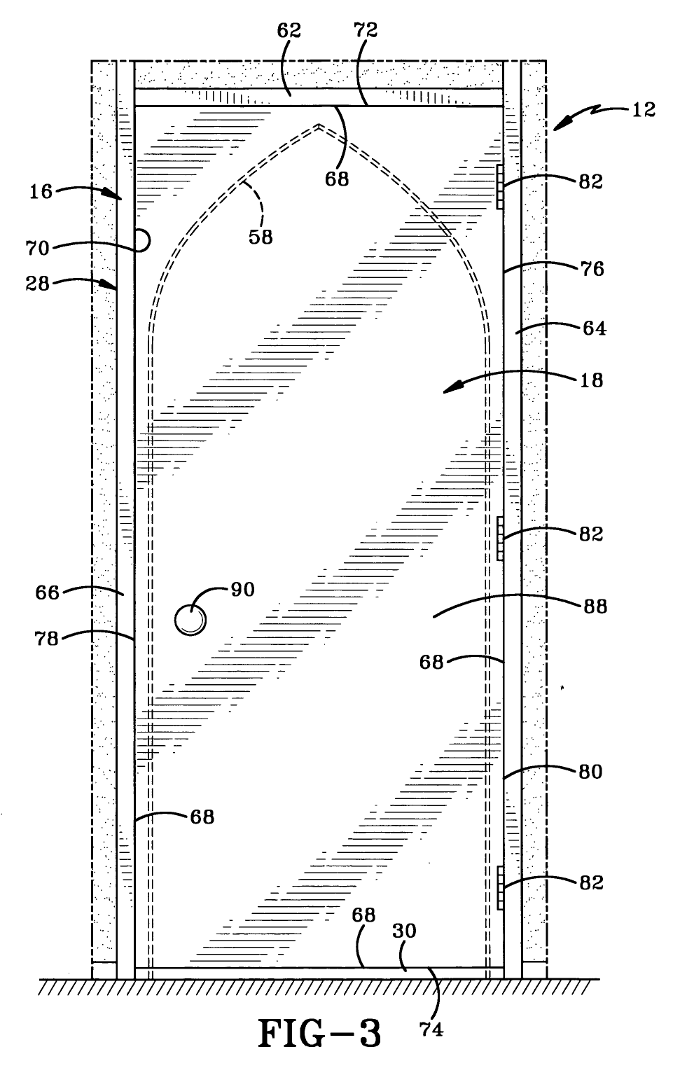

Referring to FIGS. 2-3, door frame 16 includes a front portion 26 (FIG. 2) and a rear portion 28 (FIG. 3). A horizontal baseboard 30 extends into front and rear portions 26 and 28. Front portion 26 includes first and second facia boards 32 and 34 which are mounted in abutment with the front surface of wall 8. First board 32 includes a vertical straight segment 36 and an arcuate segment 38 extending upwardly from the top of straight segment 36 and curving toward second board 34. Likewise, second board 34 includes a vertical straight segment 40 and an arcuate segment 42 which extends upwardly from the upper end of straight segment 40 and curves toward board 32. More particularly, arcuate segments 38 and 42 curve toward one another and meet at a peak 44 to define the top of front portion 26 of door frame 16. Front portion 26 further includes first and second trim strips 46 and 48 which are respectively connected to the inner surfaces of first and second facia boards 32 and 34. Trim strips 46 and 48 also abut wall 8 along an inner perimeter of wall 8 which forms the doorway opening therethrough. First trim strip 46 includes a vertical straight segment 50 and an arcuate segment 52 which are respectively connected to segments 36 and 38 of first board 32 and mimic the shapes thereof. Likewise, second trim strip 48 includes a vertical straight segment 54 and an arcuate segment 56 which are respectively connected to segments 40 and 42 of second board 34. Together, baseboard 30 and trim strips 46 and 48 have an inner perimeter 58 which is arch-shaped and thus defines an arch-shaped front door opening 60. Arcuate segments 52 and 56 of trim strips 46 and 48 curve together to meet at a peak 57 of inner perimeter 58.

Referring to FIG. 3, rear portion 28 of door frame 16 includes a horizontal top board 62 and first and second vertical boards 64 and 66. Together with the portion of baseboard 30 disposed in rear portion 28, the inner surfaces of boards 62, 64 and 66 have an inner perimeter 68 which is rectangular and thus defines a rectangular rear door opening 70 in which door 18 is disposed in the closed position.

Door 18 has a standard rectangular shape and thus has a horizontal top 72, a horizontal bottom 74 and first and second vertical sides 76 and 78. Together, top 72 and bottom 74 and sides 76 and 78 form an outer perimeter of door 80 which is of a mating configuration with and only slightly smaller than inner perimeter 68. Door 18 is pivotally mounted in a standard fashion via three hinges 82 each connected to side 76 of door 18 and first vertical board 64 of door frame 16. Door 18 has a substantially flat front surface 84 (FIG. 2) with a first door knob 86 mounted thereon extending outwardly therefrom. Likewise, door 18 has a substantially flat rear surface 88 (FIG. 3) with a second door knob 90 extending rearwardly therefrom. Door 18 may include a window (not shown) to allow visibility therethrough. Such a window may also have a shape which mimics the shape of the door opening, which would be arched shaped in the exemplary embodiment, in order to provides an additional thematic tie to the shape of door assembly 12 and window 14.

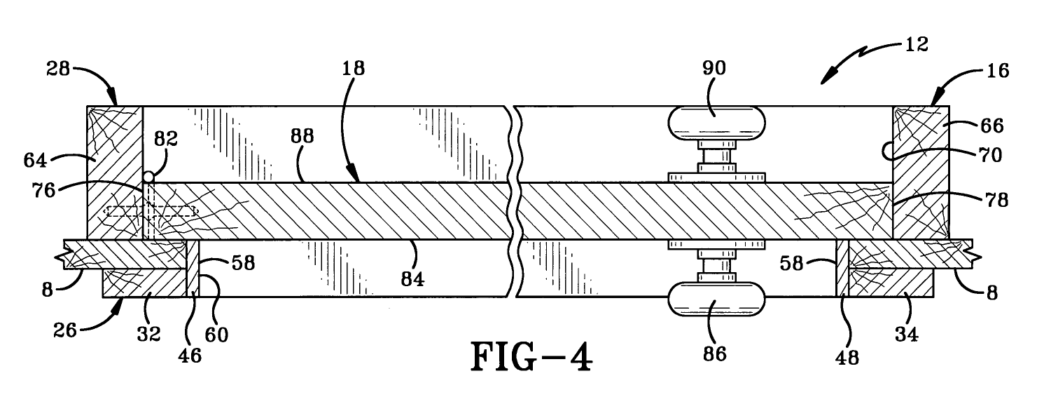

In accordance with the invention, outer perimeter 80 of door 18 and inner perimeter 68 of rear portion 28 are larger than inner perimeter 58 of front portion 26 and of a different shape. When door 18 is in the closed position as shown in FIGS. 2 and 3, it completely covers front door opening 60 except for any small space between baseboard 30 and bottom 74 of door 18 although bottom 74 and baseboard 30 typically abut one another or are closely adjacent to one another. Sides 76 and 78 of door 18 are disposed laterally outwardly of the inner surfaces of straight segments 50 and 54 and arcuate segments 52 and 56 of trim strips 46 and 48. Top 72 of door 18 is disposed above the uppermost portion or peak 57 of inner perimeter 58 of front portion 26. Thus, the upper corners of door 18 are respectively disposed above arcuate segments 52 and 56 of trim strips 46 and 48. When door 18 is in the closed position (FIG. 4), front surface 84 thereof abuts the rear surface of wall 8 and the respective rear surfaces of trim strips 46 and 48. Thus, door assembly 12 provides a standard rectangular door 18 and a non-rectangular front door opening 70 which gives door 18 the appearance of a non-rectangular shape and in particular an arch shape. This is achieved without the additional work of providing a door which actually does have the non-rectangular or arch shape of opening 70.

Referring to FIG. 6, door assembly 100 is briefly described. Door assembly 100 includes a door frame 102 having a front portion which defines an inner perimeter 104 which is non-rectangular and thus defines a front door opening 106 which is identical in shape to door opening 70 of door assembly 12. Assembly 100 further includes a rectangular door 108 having substantially the same shape and size as door 18. However, door 108 is configured as a sliding or rolling door which may slide or roll along tracks formed at the top and/or bottom thereof into a pocket in wall 8. Door 108 has an indented handle 110 for sliding door 108 between open and closed positions as shown at arrow A in FIG. 6. Door 108 thus illustrates the use of a standard rectangular sliding door to achieve the intended result of appearing to have a non-rectangular shape due to the arch-shape of front door opening.

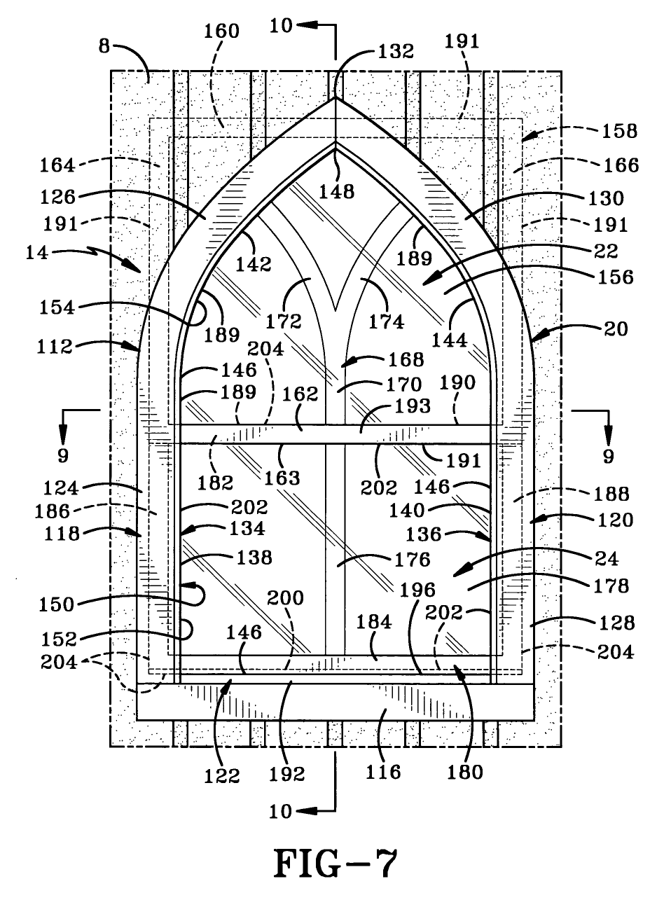

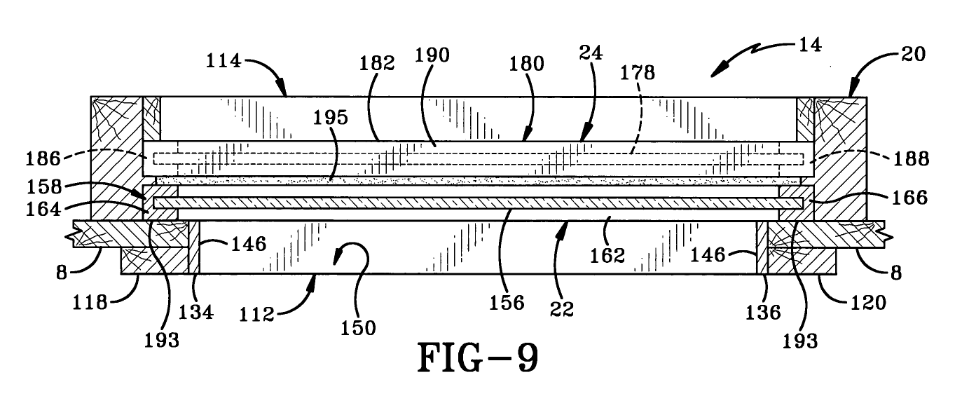

Window 12 is now described with reference to FIG. 7-10. As previously noted, window 12 includes window frame 20, upper window pane assembly 22 and lower window pane assembly 24. Window frame 20 includes a front portion 112 and a rear portion 114. Front portion 112 includes a lower horizontal facia board 116, and first and second lateral facia boards 118 and 120 extending upwardly therefrom. A horizontal ledge board 122 extends into front portion 112 and rear portion 114. A forward portion of board 122 is seated atop lower board 116. A first facia board 118 includes a vertical straight segment 124 extending upwardly from one end of board 116 and an arcuate segment 126 which curves from the upper end of segment 124 toward second board 120. Likewise, board 120 includes a vertical straight segment 128 extending upwardly from the other end of board 116 and an arcuate segment 130 which curves toward first board 118 and more particularly meets arcuate segment 126 at a peak 132.

Front portion 112 further includes first second trim strips 134 and 136 respectively connected to the inner surfaces of first and second lateral facia boards 118 and 120 and to corresponding portions of wall 8. Trim strips 134 and 136 respectively include vertical straight segments 138 and 140 which extends upwardly from ends of ledge board 122. Strips 134 and 136 respectively further include arcuate segments 142 and 144 which extend upwardly respectively from segments 138 and 140 toward one another and meet at respective upper ends thereof. Together, the upper surface of board 122 and the inner surfaces of first and second trim strips 134 and 136 form an inner perimeter 146 having a peak 148 where arcuate segments 142 and 144 meet. Inner perimeter 146 is arch-shaped and thus defines an arch-shaped front window opening 150. The shape of window opening 150 of window 14 and door opening 60 of door assembly 12 are similar and thus create a thematic association when used together on wall 8 or in the general vicinity of one another. In the exemplary embodiment, this is accomplished by the use of the arch comprising the various arcuate segments of the window frame and door frame. It is noted that in the exemplary embodiment the window frame defining opening 150 is obviously smaller than the door frame defining opening 60, but is not necessarily proportionate to the dimensions of the door frame. Upper and lower window pane assemblies 22 and 24 further divide front window opening 150 into lower and upper window openings 152 and 154, which will be further detailed after additional description of window pane assemblies 22 and 24.

Upper window pane assembly 22 includes a single upper window pane 156 and an upper sash 158 circumscribing the entire outer perimeter of upper pane 156. More particularly, sash 158 includes horizontal top segment 160 and horizontal bottom segment 162 and first and second vertical side segments 164 and 166. Bottom segment 162 has a lower surface 163. Assemblies 22 and 24 include a divider assembly which makes the window pane thereof appear to be more than a single pane. In the exemplary embodiment, a Y-shaped divider 168 is adhered to the rear surface of upper window pane 156 and is typically in the form of a thin sheet of material having an adhesive on one side for adhering to the window pane. Divider 168 includes a lower vertical divider 170 and a pair of arcuate dividers 172 and 174 which diverge away from each other from the upper end of vertical divider 170 and extend a short distance beyond inner perimeter 146 along arcuate segments 142 and 144 respectively. Divider 168 thus gives the appearance that window pane 156 includes three window panes two of which are arch-shaped similar to the overall shape of the window opening 150 and a central portion which is generally diamond-shaped between dividers 172 and 174.

A vertical divider 176 is likewise adhered to the rear surface of a lower window pane 178 of lower assembly 124. Divider 176 is aligned directly below vertical divider 170 so that dividers 170 and 176 appear to be a single divider. Lower window pane assembly 24 also includes a sash 180 extending entirely around the outer perimeter of lower window pane 178. More particularly, sash 180 includes a horizontal top segment 182, a horizontal bottom segment 184 and first and second vertical side segments 186 and 188. Top segment 182 has an upper surface 190.

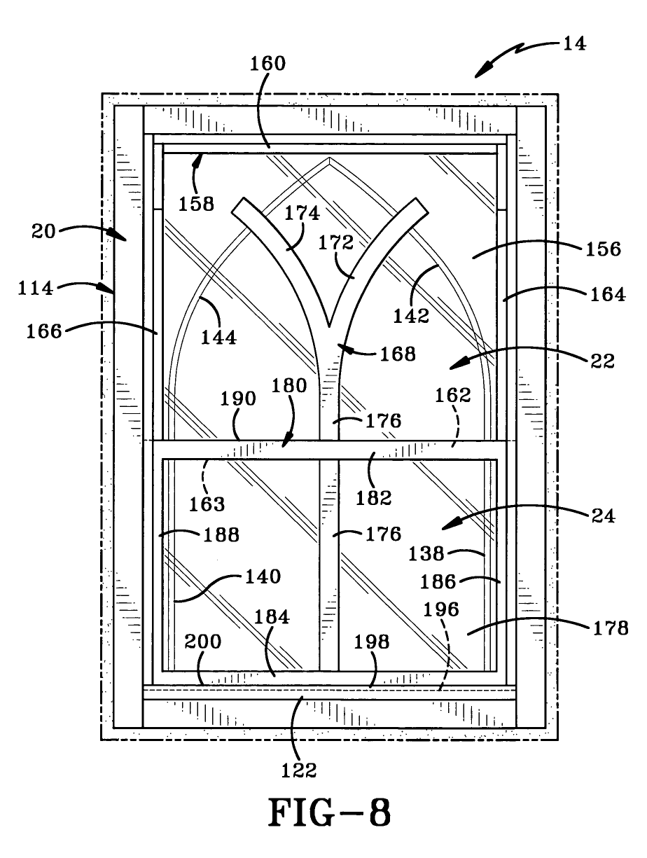

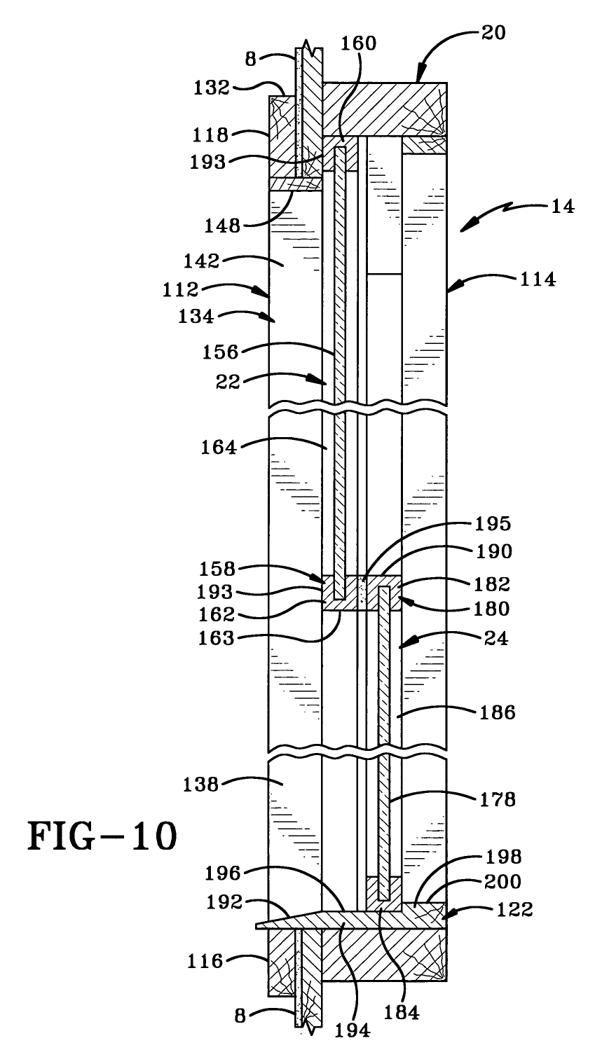

With the additional details given regarding upper and lower window pane assemblies 22 and 24, upper and lower window openings 152 and 154 are now further detailed. As viewed from the front or rear of window 14, window frame 20 has an upper inner perimeter 189 which defines upper window opening 52. Upper inner perimeter 189 includes upper surface 190 of top segment 182 and the portions of inner perimeter 146 which extend upwardly therefrom. In the exemplary embodiment, said portions of inner perimeter 146 includes the inner surfaces of arcuate segments 142 and 144 and the upper portions of vertical segments of 138 and 140. Assembly 22 has an outer perimeter 191 which is greater than upper inner perimeter 189. Upper window opening 154 is thus completely covered by upper window pane assembly 22 in its closed position as shown in FIGS. 7 and 8. Upper sash 158 of upper window pane 156 has a front surface 193, portions of which abut the rear surface of wall 8 and portions of which abut the rear surface of first and second trim strips 134 and 136. More particularly, the portions of front surface 193 along top segment 160 and first and second side segments 164 and 166 abut the rear surface of wall 8 while portions of the front surface of bottom segment 162 adjacent opposed ends thereof respectively abut the rear surfaces of vertical segments 138 and 140 at intersections therewith and a small portion of the rear surfaces of wall 8 adjacent side segments 138 and 140. Typically, a seal 195 (FIG. 10) is positioned between bottom segment 162 of upper sash 158 and top segment 182 of lower sash 180 to provide a seal therebetween when each of window pane assemblies 22 and 24 are in their respective closed positions.

To further define lower window opening 152, ledge board 122 is further described with reference to FIG. 10. Board 122 has a front tapered section 192, an intermediate seating section 194 having a horizontal upper seating surface 196, and a rear step 198 which steps vertically upward from surface 196 and has an upper surface 200. The bottom of lower window pane assembly 24 is seated on seating surface 196 when in its closed position and depending on the configuration of the window, the upper window pane assembly 22 may also be seated on surface 196 when opened. Window frame 20 thus has a lower inner perimeter 202 which defines lower window opening 152 and includes upper surface 200, lower surface 163 of bottom segment 162 and the portions of inner perimeter 146 extending therebetween. More particularly, these portions of inner perimeter 146 include the inner surfaces of the lower portions of vertical segments 138 and 140 of first and second trim strips 134 and 136. Lower and upper window openings 152 and 153 thus overlap one another as viewed from the front and the rear between lower surface 163 of bottom segment 162 and upper surface 190 of top segment 182. Lower window opening 152 has a standard rectangular shape although this may vary in accordance with the invention and thus may be a shape which is neither rectangle nor square. Lower window pane assembly 24 thus has an outer perimeter 204 which is rectangular and larger than that of lower window opening 152, as is the case with a standard window having a lower window pane assembly which opens upwardly.

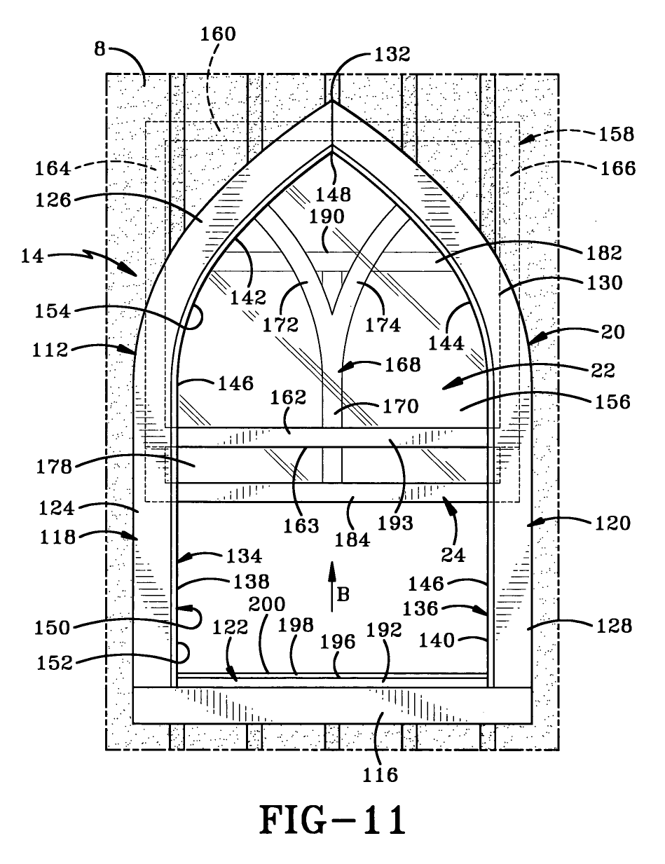

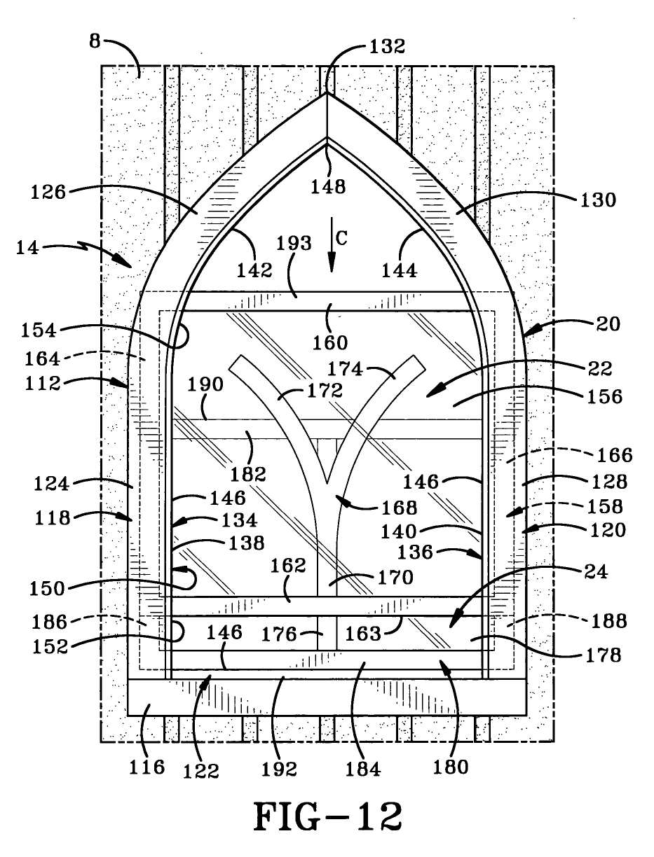

As shown in FIG. 11, lower window pane assembly 24 may be moved upwardly as indicated at arrow B to an open position to provide a rectangular opening through which air may pass. Similarly, FIG. 12 shows that upper window pane assembly 22 may be lowered as indicated at arrow C to provide a non-rectangular opening through which air may pass. In the open position of upper assembly 22, portions of front surface 193 of top segment 160 move into engagement with portions of the rear surfaces of first and second trim strips 134 and 136.

Thus, the present invention provides a door assembly having a non-rectangular door opening and a door having an outer perimeter which is larger than the door opening, which is rectangular. Similarly, the invention provides a window having upper and lower window openings at least one of which is non-rectangular and upper and lower window pane assemblies each of which is rectangular or square and has a respective outer perimeter which is respectively larger than that of the associated upper or lower window opening. Thus, the invention provides for an appearance of a window or a window pane assembly which is non-rectangular or which is non-square without forming the door or window pane assembly in the non-rectangular or non-square shape. In addition, the invention provides a door assembly and window shape that mimic one another to provide a thematic association between the door and window when mounted within a reasonable distance of one another.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. An apparatus comprising:
a window frame defining a window opening;
a first inner perimeter defining a first portion of the window opening having a first shape;
a second inner perimeter defining a second portion of the window opening;
a first window pane assembly which is mounted on the window frame, comprises a first window pane and has a first outer perimeter larger than the first inner perimeter so that the first window pane assembly is capable of covering the first portion of the window opening; the first outer perimeter having a second shape different than the first shape;
a second window pane assembly which is mounted on the window frame, comprises a second window pane and has a second outer perimeter larger than the second inner perimeter so that the second window pane assembly is capable of covering the second portion of the window opening;
at least one of the window pane assemblies being movable between open and closed positions.

2. The apparatus of claim 1 wherein the second shape is one of square and rectangular.

3. The apparatus of claim 2 wherein the first shape comprises an arch.

4. The apparatus of claim 2 further comprising a first arcuate segment on the first inner perimeter.

5. The apparatus of claim 4 further comprising a first straight segment on the first inner perimeter communicating with the first arcuate segment.

6. The apparatus of claim 5 further comprising a second arcuate segment on the first inner perimeter.

7. The apparatus of claim 6 further comprising a second straight segment on the first inner perimeter communicating with the second arcuate segment.

8. The apparatus of claim 1 wherein the first inner perimeter comprises a first surface on the second window pane assembly.

9. The apparatus of claim 8 wherein the first inner perimeter comprises a first segment of the window frame extending transversely from the first surface.

10. The apparatus of claim 8 further comprising a sash on the second window pane; and wherein the first surface is on the sash.

11. The apparatus of claim 10 further comprising a horizontal top segment on the sash; and wherein the first surface is an upper surface of the top segment.

12. The apparatus of claim 1 further comprising a first sash connected to the first window pane and circumscribing the first window pane to form the first outer perimeter.

13. The apparatus of claim 1 further comprising a Y-shaped thin layer of material connected to the first window pane and forming a divider creating an appearance that the first window pane is a plurality of window panes.

14. The apparatus of claim 13 wherein the first shape comprises an arch; and the Y-shaped divider creates the appearance that the first window pane comprises first and second arch-shaped window panes and a third generally diamond-shaped window pane.

15. The apparatus of claim 13 further comprising a lower vertical segment on the Y-shaped divider; and a vertical thin layer of material connected to the second window pane and forming a divider vertically aligned with the lower vertical segment and extending downwardly therefrom to create an appearance that the second window pane is a plurality of window panes.

16. The apparatus of claim 1 wherein the first shape comprises an arch comprising a first arcuate segment; and further comprising a thin layer of material connected to the first window pane and comprising a second arcuate segment which intersects the first arcuate segment to form an arch.

17. The apparatus of claim 1 further including a flexible layer of material adhered to the at least one window pane to form at least one divider which creates an appearance that one window pane is a plurality of window panes.

18. The apparatus of claim 1 further comprising a structure on which the window frame is mounted; a door frame mounted on the structure and having an inner circumference of a third shape defining a door opening; and a door mounted on the door frame and having an outer circumference which is greater than the inner circumference and has a fourth shape different than the third shape; and wherein the third shape is similar to the first shape.

19. The apparatus of claim 18 wherein the first and third shapes each comprise an arch.

20. An apparatus comprising:
a door frame having an inner circumference of a first shape defining a door opening; and
a door mounted on the door frame and having an outer circumference which is greater than the inner circumference and has a second shape different than the first shape.
